(19) United States
(12) Patent Application Publication
(10) Pub. No.: US 2017/0082757 A1
(43) Pub. Date: Mar. 23, 2017

(54) Determination of redundant absolute positions by means of vehicle-dynamics sensors

(71) Applicant: Continental Teves AG & Co. oHG, Frankfurt (DE)

(72) Inventors: Annemarie Kunkel, Lohmar (DE); Ulrich Stählin, Eschborn (DE); Zydek Bastian, Bad Soden (DE); Ralph Grewe, Frankfurt am Main (DE); Maxim Arbitmann, Frankfurt am Main (DE); Thomas Grotendorst, Eschborn (DE); Matthias Komar, Heppenheim (DE); Adam Swoboda, Groß-Gerau (DE)

(73) Assignee: Continental Teves AG & Co. oHG, Frankfurt (DE)

(21) Appl. No.: 15/309,400

(22) PCT Filed: May 7, 2015
(86) PCT No.: PCT/EP2015/060109

§ 371 Date: Nov. 7, 2016

(30) Foreign Application Priority Data
May 7, 2014 (DE) 10 2014 208 541.1

(51) Int. Cl. G01S 19/40; G01C 21/32; G01S 19/45

(52) U.S. Cl. CPC G01S 19/40; G01S 19/45; G01C 21/32

(57) ABSTRACT

The invention relates to a method for determining a reference position as the basis for a correction of a GNSS position of a vehicle located using a Global Satellite Navigation System (GNSS), which contains an absolute position of the vehicle, comprising: recording the absolute position of the vehicle using the GNSS when an output signal (from a motion recording sensor in the vehicle has a characteristic progression; determining the reference position based on the sensed absolute position and assigning the reference position to the characteristic progression of the output signal.

### TECHNICAL FIELD

The invention relates to a method for determining a reference position as the basis for a correction of a Global Satellite Navigation System (GNSS) position of a vehicle located by means of a global satellite navigation system.

### BACKGROUND

It is known from WO 2011/098 333 A1 that different sensor values can be used in a vehicle in order to improve already existing sensor values, to generate sensor values and thus to increase the amount of recordable information.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

The object is to improve the use of several sensor values in order to increase information.

According to one aspect of the invention, a method for determining a reference position as the basis for a correction of a Global Satellite Navigation System (GNSS) position of a vehicle located by means of a global satellite navigation system known as GNSS comprises recording an absolute position of the vehicle by means of the GNSS when an output signal from a motion recording sensor of the vehicle has a characteristic progression, determining the reference position based on the sensed absolute position, and assigning the reference position to the characteristic progression of the output signal.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification. It should be understood that the detailed description and specific examples, while indicating the preferred embodiment of the disclosure, are intended for purposes of illustration only and are not intended to limit the scope of the disclosure.

### BRIEF DESCRIPTION OF THE DRAWINGS

The properties, features and advantages of this invention described above, and the manner in which these are achieved, become more clearly and precisely comprehensible in the context of the description of the exemplary embodiments below, which are explained in greater detail with reference to the drawings, in which:

FIG. 1 shows a principle representation of a vehicle on a road;

FIG. 2 shows a principle representation of the vehicle as shown in FIG. 1 as an alternative view;

FIG. 3 shows a principle representation of a merging sensor in the vehicle as shown in FIG. 1;

FIG. 4 shows a principle representation of the vehicle as shown in FIG. 1 on the road; and

FIG. 5 shows a principle representation of the vehicle as shown in FIG. 1 on the road in an alternative view.

### DETAILED DESCRIPTION

In the figures, the same technical elements are assigned the same reference numerals and are only described once.

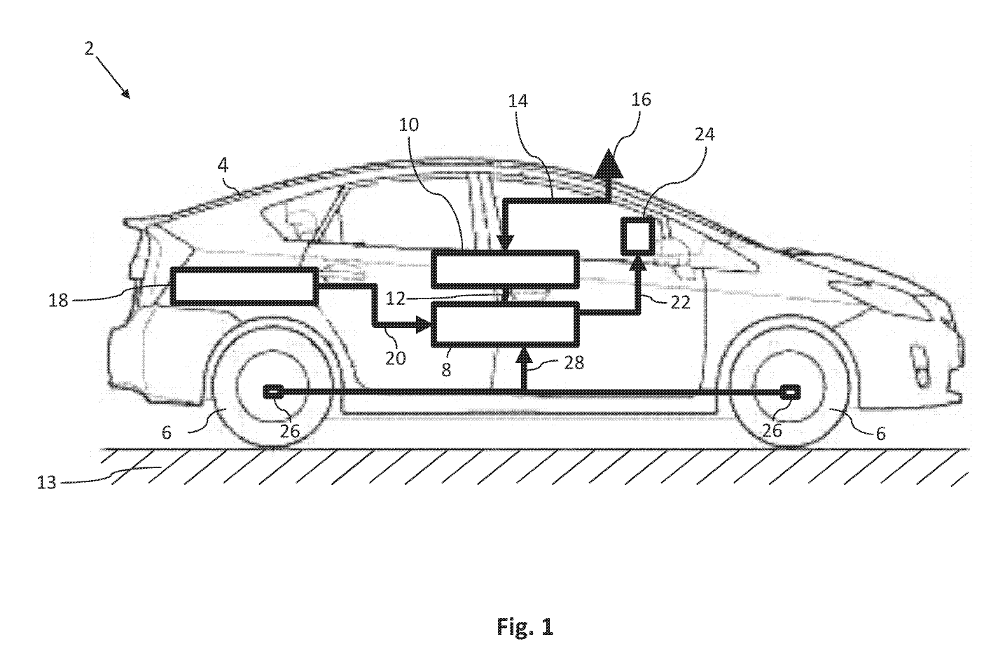

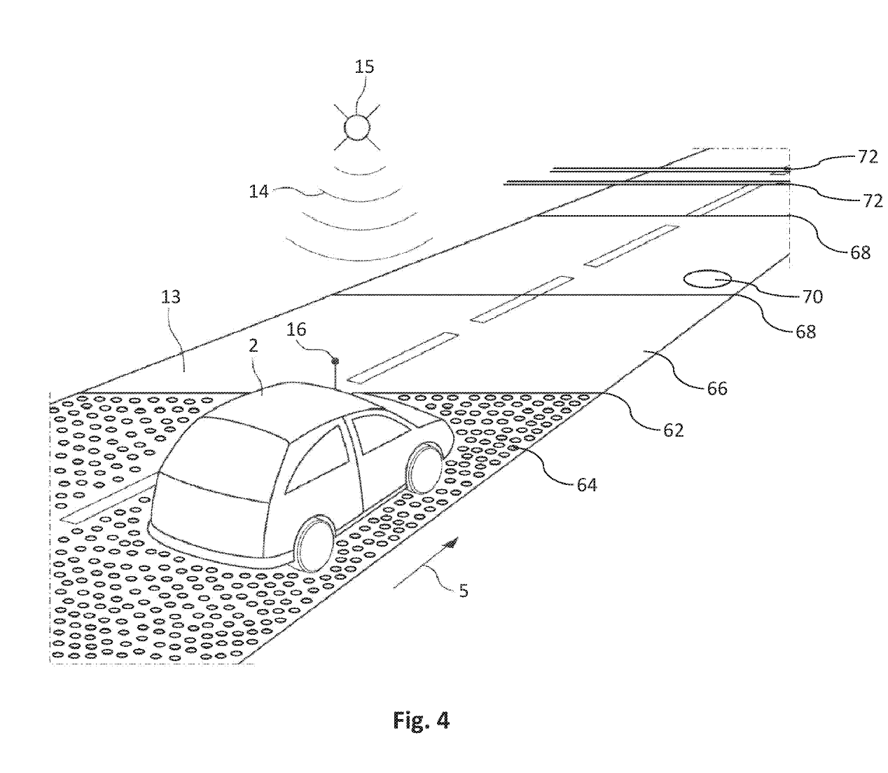

Reference is made to FIG. 1, which shows a principle representation of a vehicle 2 with a chassis 4, which is supported on wheels 6 in such a manner that it can drive, in a driving direction 5 indicated in FIG. 4. A merging sensor 8 is arranged in the vehicle 2.

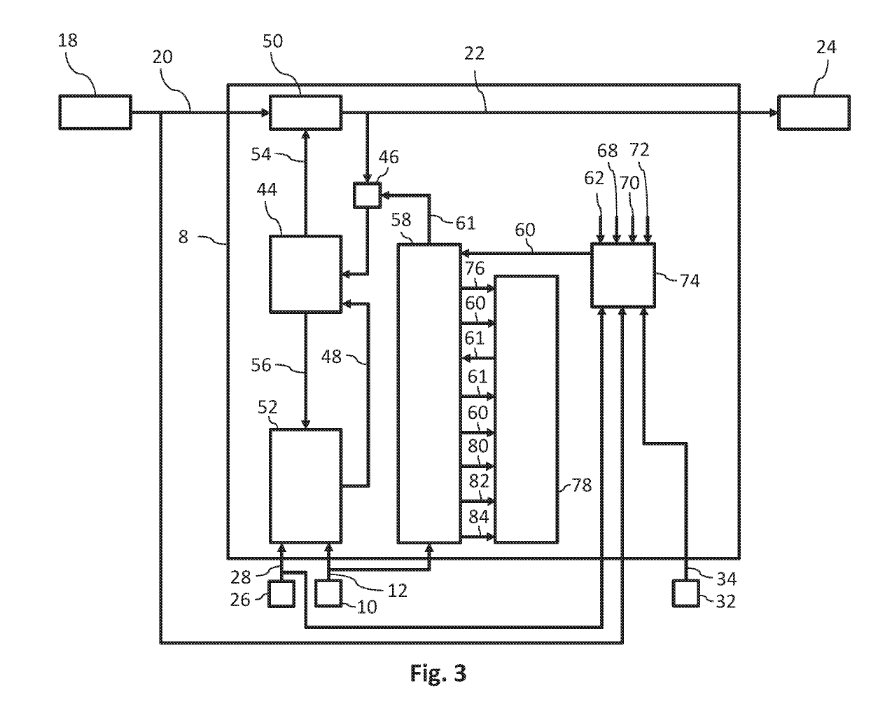

In the present embodiment, the merging sensor 8 receives position data 12 of the vehicle 2 via a Global Satellite Navigation System (GNSS) receiver 10 which is in itself known, which describes for example the absolute position 76 of the vehicle 2 on a road 13 as indicated in FIG. 3. Alongside the absolute position 76, the position data 12 from the GNSS receiver 10 can additionally describe a velocity of the vehicle 2. The position data 12 from the GNSS receiver 10 is in the present embodiment, in a manner known to persons skilled in the art, derived from a GNSS signal 14 emitted by a GNSS satellite 15 as indicated in FIG. 4, which is received via a GNSS antenna 16, and which is thus referred to below as GNSS position data 12. For details on this matter, reference is made to the relevant specialist literature.

The merging sensor 8 is in a manner yet to be described designed to increase the information content of the GNSS position data 12 derived from the GNSS signal 14. This is on the one hand necessary since the GNSS signal 14 can comprise a very low signal/interference interval and can thus be very imprecise. On the other hand, the GNSS signal 14 is not constantly available.

In the present embodiment, the vehicle 2 comprises a motion recording sensor for this purpose in the form of an inertial sensor 18, which records the vehicle dynamics 20 of the vehicle 2. As is known, these include a longitudinal acceleration, a transverse acceleration and a vertical acceleration, and a rocking rate, a pitch rate and a yaw rate of the vehicle 2. These vehicle dynamics 20 are used in the present embodiment to increase the information content of the GNSS position data 12 and for example to render more precise the position and speed of the vehicle 2 on the road 13. The more precisely rendered position data 22 can then be used by a navigation device 24 even in cases when the GNSS signal 14 is not available at all, such as when in a tunnel.

In order to further increase the information content of the GNSS position data 12, in the present invention, further motion recording sensors can also be used in the form of wheel speed sensors 26, which records the wheel speeds 28 of the individual wheels 6 on the vehicle 2.

The generation of the more precisely rendered position data 22 will be described in greater detail below in FIG. 3.

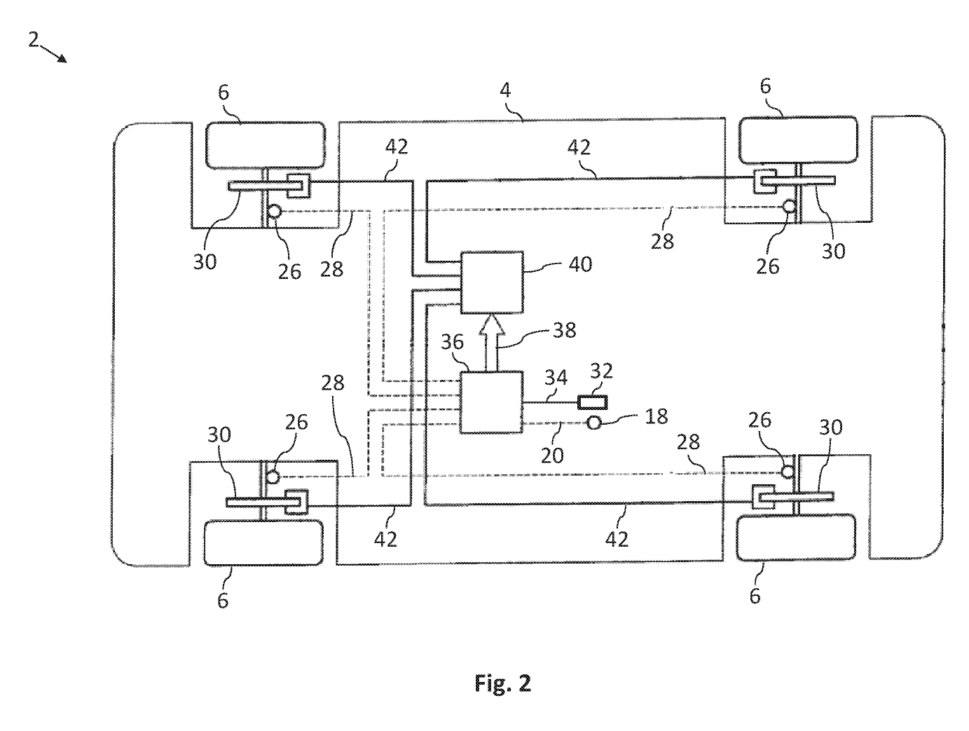

Reference is made to FIG. 2, which shows a principle representation of the vehicle 2 with a driving dynamics regulation system installed in the vehicle. Details of a driving dynamics regulation system can be found for example in DE 10 2011 080 789 A1.

Each wheel 6 of the vehicle 2 can be decelerated via a brake 30 attached in a fixed location on the chassis 4, in order to decelerate a movement of the vehicle 2 on a road not further shown.

Here, in a manner known to persons skilled in the art, it can occur that the wheels 6 of the vehicle 2 lose their contact with the ground on the road 13 and the vehicle 2 even moves away, for example, from a trajectory specified via a steering wheel (not further shown) through under-steering or over-steering. This trajectory can for example be specified from a steering angle 34 recorded via a further motion recording sensor such as a steering angle sensor 32. This movement from a specified trajectory is avoided by control circuits which are in themselves known, such as ABS (Anti-Blocking System) and ESP (Electronic Stability Program). In such control circuits, measurement data is recorded by sensors. Controllers then compare the measurement data with set data and add the measurement data to the set data by means of actuating elements.

In the present embodiment, the vehicle 2 comprises as sensors the speed sensors 26 on the wheels 6, which record as measurement data their respective speed 28 of the wheels 6. Further, the vehicle 2 comprises as a sensor the inertial sensor 18, which records as measurement data the vehicle dynamics 20 of the vehicle 2.

Based on the recorded speeds 12 and vehicle dynamics 20, a controller 36 can determine in a manner known to persons skilled in the art whether the vehicle 2 is sliding on the road 13 or even deviates from the above-named specified trajectory, and react accordingly with a controller output signal 38 which is in itself known. The controller output signal 38 can then be used by a positioning facility 40 in order for actuating elements such as the brakes 30 to be triggered via actuation signals 42, which react to the sliding and the deviation from the specified trajectory in a manner which is in itself known.

The controller 36 can for example be integrated in an engine control system of the vehicle 2, which is in itself known. Additionally, the controller 36 and the actuating facility 40 can be designed as a shared control facility.

Reference is made to FIG. 3, which shows a principle representation of the merging sensor 8 as shown in FIG. 1.

In the merging sensor 8, the measurement data already mentioned in FIG. 1 is entered. The merging sensor 8 is designed to emit the more precisely rendered position data 22. The basic principle in this regard is to compare the information from the GNSS position data 12 with the vehicle dynamics data 20 from the inertial sensor 18 in a filter 44, and thus to increase a signal/interference interval in the GNSS position data 12 of the GNSS receiver 20 or the vehicle dynamics data 18 from the inertial sensor 20. For this purpose, the filter can be designed as required. In one embodiment a filter is a Kalman filter which has a comparatively low computer resource requirement from other filters.

Via a correction member 46 described in more detail below, the more precisely rendered position data 22 of the vehicle 2 and the comparative position data 48 of the vehicle enter the Kalman filter 30. The more precisely rendered position data 22 is in the present embodiment generated from the vehicle dynamics data 20 in a strapdown algorithm 50 known for example from DE 10 2006 029 148 A1. It contains more precisely rendered position information about the vehicle 2, as well as other location data about the vehicle 2, such as its velocity, its acceleration and its heading. By contrast, the comparative position data 48 from a model 52 of the vehicle 2 is obtained, which is initially fed from the GNSS receiver 10 with the GNSS position data 12. From this GNSS position data 12, the comparative position data 48 is then determined in the model 52, which contains the same information as the more precisely rendered position data 22. The more precisely rendered position data 22 and the comparative position data 48 differ merely in terms of their values.

Based on the more precisely rendered position data 22 and the comparative position data 48, the Kalman filter 30 calculates an error content 54 for the more precisely rendered position data 22 and an error content 56 for the comparative data 48. Below, an error content should be understood as at least meaning an overall error in a signal, which is compiled of different individual errors when recording and transmitting the signal. With the GNSS signal 14 and thus with the GNSS position data 12, a corresponding error content can consist of errors of the satellite track, the satellite clock, the remaining refraction effects and errors in the GNSS receiver 10.

The error content 54 of the more precisely rendered position data 22 and the error content 56 of the comparative data 48 is then added to the model 52 in order to correct the more precisely rendered position data 22 or the comparative position data 48. This means that the more precisely rendered position data 22 and the comparative data 48 are iteratively purified of their errors.

The merging filter 44 can in the manner described above correct the vehicle dynamics 20 of the vehicle 2 extremely well, which are recorded by the inertial sensor 18, based on the GNSS position data 12 and the wheel speeds 28.

However, the filter behaves differently with an absolute position of the vehicle 2, for which in fact only the GNSS receiver 10 would be available, which issues the absolute position 76 of the vehicle 2 in the GNSS position data 12. Since in the vehicle 2, no comparative values are available for the absolute position 76 of the vehicle 2, errors such as atmospheric interferences cannot be corrected when recording the absolute position 76, and thus reduce the degree of integrity of the more precisely rendered position data 22.

In order to increase the degree of integrity of the more precisely rendered position data 22, the present embodiment recommends that as a comparative value for the absolute position 76 of the vehicle 2, a reference position 61 should be created experimentally. For this purpose, a position determination facility 58 is provided in the present embodiment, which is based on a characteristic progression 60 from an output signal 20, 28, 34 of the above-named motion recording sensors 18, 26, 32.

The output signals 20, 28, 34 have the above-named characteristic progression 60 when the vehicle 2 passes characteristic excitations shown in FIG. 4 on the road 13. Individually, these are a surface transfer 62, in which a covering of the road 13 changes from cobblestones 64 to concrete 66, transverse joins 68 in the concrete 66, manhole covers 70 and tracks 72 which traverse the road 13. All changes in characteristics come under consideration on the road 13 as a characteristic excitation 62, 68, 70, 72 which excite the above-named motion recording sensors 18, 26, 32 in a reproducible manner over a sufficiently brief period of time, and which permit an unequivocal allocation to the absolute position 76 of the vehicle 2. The cobblestones 64 themselves would therefore tend to be unsuitable, since they would excite the motion recording sensors 18, 26, 32 over too long a time period, so that no unequivocal absolute position can be assigned to this excitation.

“Sufficiently brief” should at least be understood as dependent on velocity. “In a reproducible manner” should at least be understood in such a manner that when the vehicle 2 passes a characteristic excitation again, the above-named motion recording sensors 18, 26, 32 emit an output signal 20, 28, 34 with the same characteristic progression 60. Further understanding of both terms may also be determined as what is understood by one skilled in the art.

The characteristic excitations 62, 68, 70, 72, which would lead to the output signals 12, 28, 34 of the motion recording sensors 18, 26, 32 to conduct a characteristic progression, can be pre-specified by a selection filter 74, which then filters the characteristic progression 60 out of the output signals 12, 28, 34 and which issues it to the position determination facility.

Together with the characteristic progression 60, the position determination facility 58 receives the position data with the absolute position 76 at which the vehicle is located at the point in time at which the characteristic progression 60 occurs. The position determination facility 58 sends a query to a storage facility 78, on the basis of the characteristic progression 60 and the absolute position 76, as to whether in an area around the absolute position 76, on which the characteristic progression 60 was recorded, a reference position 61 is already stored, at which this characteristic progression 60 has already been recorded. The area around the absolute position 76, in which a reference position 61 is permitted to lie, should here on the one hand be selected too narrowly in terms of location, so that a correction of the absolute position 76 is possible at all. On the other hand, the area around the absolute position 76 in which a reference position 61 is permitted to lie may also not be selected too broadly, so that two different characteristic excitations 62, 68, 70, 72 are not erroneously assigned to the same reference position 61.

If the storage facility 78 responds with an already stored reference position 61 in the area around the absolute position 76, the position determination facility 58 corrects the stored reference position 61 based on the newly sensed absolute position 76. This can for example be a formation of an average value, through a formation of a weighted average value, through a filter structured in the same way as the filter 44, or any other filter required, with which the sensed absolute positions 76 in the area of a characteristic excitation 62, 68, 70, 72 can be corrected over time to the most precise possible reference position 61. The corrected reference position 61 is then as an option again stored in the storage facility 78 together with the relevant characteristic excitation 60. At the same time, the corrected reference position 61 is issued to the correction member 46, which can then render more precise the more precisely rendered position data 22 in the same manner as the filter 44 based on the corrected reference position 61.

If no reference position 61 has yet been stored in relation to a characteristic excitation 60, the position determination facility 58 can store together in the storage facility 78 the current absolute position 76 as the corrected reference position 61 together with the characteristic excitation 60. The position determination facility 58 could also issue this reference position 61 which has in this manner been corrected to the correction member 46, although here, no greater precision is achieved in the more precisely rendered position data 22, since the corrected reference position 61 is the same as the absolute position 76 currently contained in the position data 12.

As an alternative, the correction of the more precisely rendered position data 22 based on the corrected reference position 61 could also be halted when the reference position 61 is classified as being still too imprecise. For this purpose, for example, a numerical value 80 could be stored together with the reference position 61 in the storage facility 78, which indicates how often the reference position has already been corrected based on an absolute position 76. If this numerical value is too low, the correction of the more precisely rendered position data 22 based on the corrected reference position 61 can be halted.

Finally, the scenario should also be taken into account that certain characteristic excitations 62, 68, 70, 72 may in time no longer be present, for example as a result of construction measures or similar. If for example the surface on the road 13 is renewed and the cobblestones 64 and concrete 66 are replaced by an asphalt surface, then the characteristic excitation could disappear in the form of the surface transfer 62. For this purpose, a degree of integrity 82 can additionally be stored in the storage facility 78. This degree of integrity 82 indicates how reliable the reference position 61 in the storage facility 78 is. Each time when the position determination facility 58 reads off a reference position 61 for which a characteristic progression 60 is stored, and which does not however record a characteristic progression for this reference position 61, the position determination facility 58 can reduce the degree of integrity 82 associated with this reference position 61. If the degree of integrity 82 falls below a certain threshold, the position determination facility 58 can delete the corresponding reference position 61 with all associated data from the storage facility 78 with a delete command 84.

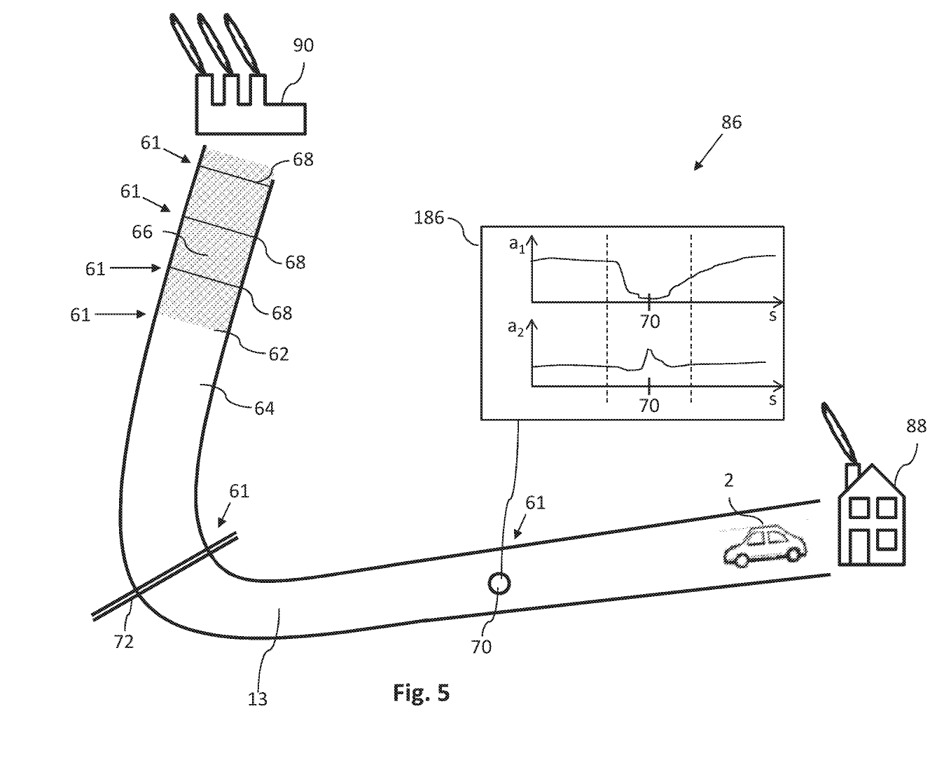

Reference is made to FIG. 5, which shows a principle view of a map 86 which can be created with the individual reference positions 61.

The vehicle 2 should travel to and fro on a daily basis on the road 13 between a home 88 of the driver of the vehicle 2 and their place of work 90.

On the road 13 in FIG. 5, the individual characteristic excitations 62, 68, 70, 72 are again indicated on the reference positions 61. By recording the individual reference positions 61 on which the individual characteristic excitations 62, 68, 70, 72 are recorded and learned, the map can be created which is independent from a map in the navigation system 24.

The map 86 can, as described above, be used to correct the absolute position. At the same time, the map 86 can also be used or supplemented in order to store e.g. driving, velocity, hazard, driver type and set velocity profiles. Only the adjustment needs to be made that the characteristic progression of the vehicle acceleration, in particular the longitudinal acceleration, if necessary also the transverse acceleration, is recorded and assigned to the reference position.

In FIG. 5, this is explained with reference to the reference position 70 as an example. The diagram 86 shows the progression of the longitudinal and transverse acceleration a₁, a₂ of the vehicle 2 in the area of the reference position 70. The driver who regularly travels over this point brakes shortly before the uneven surface on the road and drives around it, so that in the longitudinal acceleration a₁ a braking procedure is recorded and in the transverse acceleration a₂ a swerving procedure is recorded. The progression of the acceleration is stored for the reference point and can be evaluated and used in order to e.g. determine set velocities for this reference point. As an alternative, the progression of the acceleration and velocity can be determined over the entire route of a journey in order to create a velocity profile. This enables further utilization scenarios as will be described below.

A further example is described below. From the data of the longitudinal acceleration sensor in combination with the velocity progression, conclusions can be drawn regarding uneven surfaces on the road, e.g. brake humps designed to reduce speed at the beginning of 30 km/h zones.

The velocity will typically decrease from an initial velocity which is more or less constant to a relatively low velocity of possibly 5-10 km/h, in order to increase to a higher velocity of e.g. 30 km/h shortly afterwards. At the lowest velocity value, a series of characteristic peaks in the signal of the longitudinal acceleration can be recorded. The first peak here reproduces to a high degree of accuracy the beginning of the uneven surface on the road in connection with the vehicle position and geometry, while the last peak reproduces the width of the uneven surface. The height of the peaks in combination with the velocity can be used to classify the height of the uneven surface.

If the peaks are also visible in the signal of the transverse acceleration, this indicates an uneven surface which does not extend over the entire road width.

This analysis can be conducted either already in the vehicle, and transmitted to the back end in a resource-saving manner as information “road uneven surface/reference position”, or the back end collects the raw data and conducts the calculation itself. In vehicles equipped accordingly, a camera can also provide additional corresponding information. In any case, the back end can statistically evaluate the data regarding the uneven surfaces on the road, enter it into the map and distribute it to vehicles.

Here, the movement data or acceleration data may be supplemented by further data or parameters relating to the driving conditions and/or driver type, e.g.: road state (ice, dry, wet, snow, etc.); weather conditions; lighting conditions; and vehicle type. Additionally, only vehicles which drive freely, i.e. have no other traffic in front of them, may be included in the statistics described. In this way, a cluster formation is possible according to parameters, which is important for setting warning, assistance and automation systems. In heavy rain, one drives e.g. more slowly than when it is dry.

From this, the opportunity arises, for example, of creating personalized velocity profiles. It is recommended that the velocity of a driver is recorded linked to driving positions, and this is compared to other velocity profiles, preferably taking into account the above-named parameters. The data can also be recorded using mobile end devices such as smartphones. As one option, driver profiles can be created by recording the acceleration and/or velocity progressions over an entire route and then comparing them with other progressions. Alternatively, only the corresponding progressions at characteristic points, i.e. narrow curves or brake threshold, can be recorded and compared to progressions of other drivers.

The evaluation of this data over a longer time period enables a classification of the driver into certain classes of driving behavior. These classes are derived from the statistically evaluated velocity profiles. Classification is conducted according to the following subdivision, for example: economic driving behavior (slower than the average); average driving behavior; sporty driving behavior (faster than the average). This classification can subsequently be taken into account for personalized route planning or when setting assistance systems.

In this manner, the following problem can be solved in a highly effective manner. The set velocity which results does not always correspond to the velocity which would be selected when driving manually. As an example, driving round a narrow curve can be used here, the progression of which is difficult to see by the driver, and which is driven in different ways depending on the driver type. Here, an economic or cautious driver typically selects a velocity which is below the set velocity, which is calculated on the basis of the parameters named above. This can lead to a situation in which the driver feels uncomfortable or fearful when assistance or automation systems are activated, since for them, the system drives too fast around the curve. Through empirically determined set velocities, the systems can be set to assist the driver or to render them closer to autonomous driving in real life.

Alternatively, the typical velocity can also be used as an input parameter for calculating the set velocity. Alternatively, the set velocity calculation can be used based on the previously described parameters, in order to interpolate between the typical velocities (sampling points) in order to then achieve a jolt-free progression of the set velocity to the level of the typical velocities.

A further field of application of such an acceleration or velocity map is the detection of hazardous points. A hazard map can thus also be produced on the basis of the above-named maps.

The high data recording benefits among other things from the fact that a large proportion of the velocity profiles is communicated by drivers with knowledge of the area. These drivers know the hazardous points common in the area, such as schools, pedestrian crossings or narrow points as a result of their driving along the routes on a daily basis, and feed their cautious driving style into the statistics. As a result, warnings of hazardous points and recommended velocities can be transmitted to drivers not familiar with the area. In addition, an HMI can be used to issue a warning when the driver significantly exceeds the recommended velocity.

Examples of hazardous points are dangerous exits onto the road, which are poorly visible due to buildings or similar. In these areas, a velocity is recommended which is lower than that which would be enabled by the progression of the road. The point in time of the recording also plays a role alongside the position. Particularly in positions close to public transport stations, increased pedestrian numbers can be anticipated during peak rush hour traffic. Here, pedestrians frequently tend to select short routes which may deviate from pedestrian crossings. At the corresponding times, a slower velocity is also recommended here.

Alongside the regularly occurring hazardous points, those hazardous points could also be recorded which are caused by temporary hazards, such as drivers on the wrong side of the road.

Specifically, a method is therefore recommended which comprises: recording velocities of a vehicle 2 in relation to absolute positions of the vehicle, which is determined using the GNSS 15, in particular when an output signal 20, 28, 34 from a motion recording sensor 18, 26, 32 in the vehicle 2 has a characteristic progression 60; communicating the velocity and absolute position to an external sever; comparing the velocities of several vehicles on the absolute positions, in particular taking into account time, weather conditions, time of year, road conditions, etc.; and detecting noticeable velocity changes.

This example method can be further developed by taking into account data from or regarding fixed installed road facilities, such as Road Side Units for vehicle-to-x communication, zebra crossings, public transport stations, etc.

The vehicles can use the data in different ways: warning to the driver regarding uneven surfaces on the road, visual, or tactile, via a Force Feedback Pedal; automatic adaptation of the set velocity in the cruise control; for vehicles with an active chassis, the chassis can be conditioned accordingly; through the skilled combination of the precise vehicle position and a reduction of the brake pressure, the first jolt when impacting a vehicle from behind can be comfortably reduced to a brake threshold; and verification of the data relating to the uneven surfaces on the ground which is possibly supplied by a camera.

A further exemplary embodiment, which can be implemented independently of or in combination with the above exemplary embodiments, relates to a method for creating a map via communication means, comprising: recording the absolute position 76 of the vehicle 2 by means of the GNSS 15, when an output signal from a communication module of the vehicle, such as a mobile radio unit or GNSS unit 15 has a characteristic progression 60, in particular a reduction in signal strength; determining a reference position based on the sensed absolute position; and assigning the characteristic progression of the output signal to the reference position, preferably together with the signal strength.

The method can be supplemented by being combined with a method for determining a reference position according to the first exemplary embodiment above, in order to increase the precision of the position. Further, the data can be stored and evaluated in a back-end server.

Therefore it is for example possible, within the framework of a loosely or tightly coupled GNSS, to improve the location of a vehicle by merging the absolute position determined via GNSS with vehicle dynamics. In simplified terms, a reference position is updated with the vehicle dynamics. Thus, the updated reference position based on the vehicle dynamics is available alongside the absolute position determined by the GNSS, which can then be corrected among themselves through sensor merging.

The reference position, which can be updated by means of the vehicle dynamics, is however ultimately only based on the absolute position determined via GNSS. Since in the vehicle, no alternative sensor system is available in the vehicle which could provide the absolute position of the vehicle in an alternative manner. Thus the basic principle of the sensor merging is undermined, that in order to achieve a more precise absolute position of the vehicle, different information sources should be linked. This has a clear influence on the quality of the merged sensor data.

Within the framework of the vehicle dynamics sensors, on the basis of a characteristic progression of its output signal, a characteristic excitation of one of the vehicle dynamics sensors is detected. The characteristic progression of the output signal, which belongs to the recognized characteristic excitation, can then be stored together with the currently determined absolute position as a reference position. If the vehicle again passes the absolute position at which the output signal of the vehicle dynamics sensors has the characteristic progression, independent information which is more congruent with the basic principle of sensor fusion is available to the absolute position determined by GNSS as a reference position for the continuation by means of vehicle dynamics.

However, the recording of the characteristic progression is not restricted to pure vehicle dynamics sensors, but can be realized with any motion recording sensor in the vehicle from the output signal of which a functional association with the absolute position of the vehicle could be read. For this purpose, the selected motion recording sensor should be set up in a particularly practical manner in such a way that its output signal is in a certain manner dependent on locally dependent characteristics of the road on which the vehicle is moving. This can for example be its surface structure or its progression. These locally dependent properties of the road can then be recorded with the motion recording sensor as a characteristic point and used as a reference position, which can then be recognized at any time based on a characteristic pattern in the output signal of the motion recording sensor. Characteristic points of this type can for example be uneven surfaces caused by the structure of the road. Such uneven surfaces caused by structure are to be found in exits from courtyards, garages, etc., on manhole covers, on transverse joins on roads with concrete surfaces, on material changes to the road surface such as from asphalt to cobblestones, or on tracks which cross the road.

Under certain circumstances, further sensors are involved when recognizing the characteristic points in the output signal from the movement sensor, in order for example to measure in different axes the characteristic excitation of the motion recording sensor which forms the basis of the characteristic progression in the output signal of the movement sensor. Thus, for example, it could be taken into account whether such a characteristic excitation is an excitation with an expansion transverse to the direction of driving of the vehicle, as occurs for example with the above-named tracks.

In principle, any sensor in the vehicle could be used as a motion recording sensor which measures a position and/or a speed and/or an acceleration of at least one component of the vehicle or also an acceleration of the entire vehicle. Here, the position, velocity or acceleration does not necessarily have to be linear, but can for example also be recorded in an angle form. In a particular manner, sensors are eligible as motion recording sensors which are used within the scope of a vehicle dynamics regulation, i.e. wheel speed sensors, steering angle sensors, acceleration sensors and/or rotation rate sensors. Equally, tire pressure sensors can be used which can detect a rapid change to the tire air pressure and thus for example allow a conclusion to be reached that tracks are present which run transverse to the rolling direction of the tires.

The above-named reference position can further also be additionally learned for storing purposes. “Learning” should at least be understood as being the computer generation of knowledge from experience, wherein the knowledge within the scope of the method presented is the reference position, and the experience is different absolute positions which can be assigned to the characteristic progression of the output signal from the motion recording sensor. Here, learning normally comprises a filter process. This filter process can be designed in such a manner that with a renewed recording of an absolute position by means of the GNSS, the reference position already stored is corrected based on the newly sensed absolute position. This means that the reference position is corrected within the scope of learning. This correction is all the more effective and above all more reliable the more frequently the characteristic progression of the output signal has already been recognized from the motion recording sensor, and thus the higher the number of learning procedures of the reference position or iterations is, since with the frequency of the learning procedures, statistical effects are offset, which reduces the imprecision of the reference position.

In addition, a numerical value can then be assigned to the reference position, which shows how often the characteristic progression in the output signal from the movement sensor has been recognized. Possibly, a further item of information can also be assigned to the reference position to this numerical value, which indicates how reliably the current absolute position could be determined. For example, ambient conditions during the recording of the individual absolute positions, which form the basis of the reference position, can be incorporated into this information. Such ambient conditions can be the quality of the GNSS signals, the scattering of the absolute positions, the general availability of the GNSS signals when the characteristic progression in the output signal from the movement sensor has been detected, etc.

In technical terms, several different concepts can be used for learning. Thus for example, neuronal networks, support vector machines or neuro-fuzzy approaches are feasible.

In a further development, recording a further absolute position of the vehicle when the output signal from a motion recording sensor of the vehicle has a further characteristic progression which differs from the characteristic progression. As a differentiation between the further characteristic progression and the characteristic progression named above, any features in the output signal of the motion recording sensor can be sought. For example, the output signal can be examined with regard to its form for the purpose, or subjected to an FFT (Fast Fourier Transform). When both characteristic progressions have the same form, this can also be differentiated via their time interval from each other.

In order to differentiate two characteristic progressions at different times from a single characteristic progression which is based on a single characteristic excitation, which passes over the vehicle twice at a certain interval, the associated absolute position recorded via the GNSS is taken into account when recording a characteristic excitation based on a characteristic progression in the output signal. As long as this is equal to a specific tolerance, a characteristic progression recorded belongs to a single characteristic excitation. In order to take this tolerance into account, an interval between the characteristic progression and the further characteristic progression could fulfill a predetermined condition, according to which the interval between two characteristic excitations is advantageously sufficiently large that a differentiation between two excitations is easily possible. Here, for example, the GNSS used, the quality of the GNSS receiver, the number of satellites received and the number of frequencies used can be taken into account in order to define the predetermined condition, and in particular the interval.

In another further development one embodiment of a method also comprises deleting the reference position based on a further predetermined condition. This predetermined condition could be defined as a forgetting factor, by means of which old reference positions can in time again be removed from a storage facility which acts as a memory. Alternatively, old reference positions can also be weighted using the forgetting factor, and thus lose their significance with time. In this way, changing conditions can also be taken into account, such as when due to changes in the road progression a certain reference position can no longer be approached with the vehicle.

A further possibility would be a change to the surface quality of the road, as a result of which a certain characteristic excitation at a reference position could no longer be recorded. If such a reference position, at which in actuality a characterizing excitation were again to be expected due to the history, is again driven over without a characteristic excitation being recognized, a degree of integrity for the assignment between the reference position and the characteristic progression of the output signal could be downgraded. If this degree of integrity falls below a threshold value for the corresponding reference position, the reference position and all its assigned data could be entirely deleted from the storage facility. Thus it is also possible to remove the reference position regarding excitations named above which disappear due to construction measures on the road or other effects from the system without the information that a characteristic excitation exists at this reference position having to be manually deleted from the system.

According to a further aspect of the method comprises the steps of determining a reference position using one of the methods named above and entering the specific reference position into the map as a map position. Within the scope of this method, it is not necessary to reserve a digital map with reference positions and characteristic excitations as a basis, i.e. data which is present a priori, in the vehicle. The information stored in a digital map is then generated during the use of the method presented and is thus individual for each single vehicle in which the method presented is used.

According to a further aspect of the method, a control device is installed for implementing one of the methods presented.

In a further development of the control device presented, the device presented comprises a storage facility and a processor. Here, one of the methods presented is stored in the form of a computer program, and the processor is designed to implement the method when the computer program is loaded from the storage facility into the processor.

According to a further aspect of the system, a computer program comprises program code means in order to implement all steps of one of the methods presented when the computer program is implemented on a computer or one of the devices presented.

According to a further aspect of the system, a computer program product contains a program code which is stored on a data storage device which can be read by a computer, and which, when it is run on a data processing facility, implements one of the presented methods.

According to a further aspect of the system, a vehicle comprises a control device presented.

The object is further attained according to a third aspect of the system by means of a method for recording a map comprises recording an absolute position of a vehicle by means of a GNSS position which is determined by a Global Satellite Navigation System (GNSS), wherein the absolute position is recorded when an output signal from a motion recording sensor, namely an acceleration sensor, a velocity sensor, wheel speed sensor, of the vehicle and/or or a mobile end device with an acceleration sensor comprises a characteristic progression; determination of a reference position based on the sensed absolute position; and assignment of the characteristic progression of the output signal to the reference position or absolute position.

The system utilizes the finding that the linking of the acceleration data with the absolute position is particularly advantageous and offers important data for use in order to increase driving safety and driving comfort, as is described further below. On the one hand, it is possible to determine the state of the road on the basis of the acceleration. Additionally, the data on the acceleration, in particular the progression of the acceleration data, also provide information on the behavior of drivers. Both utilization scenarios can be used in an optimum manner when they are regularly collected and in a large number, and are referenced to a reference position. In this manner, particularly reliable and accurate average values on the road state, driver type, hazard points or other information can be determined, which can be used in relation to the location. Here, this data can be determined without additional effort on the part of the driver, and they are not distracted to any significant degree from their main activity of driving the vehicle. The improved position recording using the method according to the first aspect of the solution here assists in assigning the acceleration progressions to a position in the most precise manner possible. Since for the first method, the data from the movement sensor is already present, the first method described also does not need to be significantly changed.

The data is used by one or more acceleration sensors which are installed in the vehicle. Alternatively and in addition to this, mobile end devices, such as smartphones, which are affixed in a holder in the car, can be used to record the data.

If the end device is used as an alternative, i.e. only a mobile end device is used for data recording, the data can be linked to the absolute position in a centrally administered map or a back-end server. Here, the acceleration data can be linked to the absolute position via a comparison with the position recorded by the end device or via a time stamp. The data can be transferred back into the vehicle via other vehicle interfaces, such as vehicle-to-X systems or navigation systems.

If the end device is used in addition to the acceleration sensors in the vehicle, the data can already be compared in the vehicle via a direct connection between the vehicle and the end device, before being merged and/or validated before being stored and transmitted externally.

The he progression of the acceleration of the acceleration sensor is recorded linked to the reference position. The progression of the acceleration is recorded over a certain period and to store it in relation to a reference position. For example, the progression before and after a braking threshold is recorded, stored and referenced to the position of the braking threshold. On the basis of the changes in the accelerations, different information about driving processes which take place on the braking threshold itself can be determined. Furthermore, a driving recommendation can be determined from this if sufficient data quantities are available.

The progression of the longitudinal acceleration sensor is recorded in relation to reference positions, or a pre-defined route or time duration before and after the respective reference position. The longitudinal acceleration sensor records the data of braking and starting processes, which allow conclusions to be made regarding driver behavior as well as road characteristics such as potholes, brake thresholds or similar. In addition to this, the velocity of the vehicle can accordingly be recorded at reference positions or along a route.

The method can further comprise evaluation of the acceleration progression, and detection of uneven surfaces on the road on the basis of acceleration peaks. Additionally, the method can further comprise detection of uneven surfaces on the road on the basis of a road image recorded using a camera.

As a supplement to the data from the camera image, acceleration sensors can be used in order to redundantly detect the reference points and/or to validate them. As an alternative, the camera can also be used for the pre-detection of reference points or noticeable points on the road in order to then initiate an intervention in the vehicle dynamics or implement the storage of acceleration data. Conversely, the camera images and data can be validated using the acceleration data.

The method can further comprise the creation of a locally and/or centrally administered map for uneven surfaces on the road. It can on the one hand be provided that in the vehicle, only data is recorded and the evaluation of the data is conducted using an external system or a back-end server. In this manner, the computing capacity in the vehicle can be kept at a low level. In the simplest version, the map would contain the acceleration data which would be linked with the respective reference position. The map could be supplemented by a velocity profile. Alternatively, an evaluation of the data recorded can also already take place in the vehicle, and this evaluation can be stored so that the vehicle can act as autonomously as possible. The vehicle's own data can if necessary also be supplemented by external data. This variant can also be combined with one in which the recorded and evaluated data is compiled by an external system or a back-end server to produce a more complete map.

The method can further comprise by means of the fact that the uneven surfaces on the road are classified depending on acceleration peaks. The height of the acceleration peaks can in particular be used to detect unusual brake situations and thus hazardous situations.

The method can further comprise that the progression of the acceleration is linked to further driving situation, driver type and/or vehicle parameters. In this manner, a reliable evaluation and derivation of driving recommendations is possible. Overall, with the embodiment, the aim is to achieve a situation in which the individual driving maneuvers are considered in the context of the ambient conditions.

The method can further comprise by means of the progression of the acceleration and the respective parameters, acceleration progression clusters or clusters of velocity profiles are created.

The method can further comprise set velocities or hazardous points are derived from the progression of the acceleration and/or from the uneven surfaces on the road. This information can be used in a wide range of different forms. In a simple form, it could serve to warn the driver of hazardous situations. Furthermore, it could also serve to intervene in the vehicle dynamics of the vehicle.

Additionally, the set velocity is used for determining the velocity of the vehicle, the velocity of which is implemented by a cruise control or autonomously. Since the set velocities are an empirical set velocity, the degree of acceptance by the driver could be higher here than with a velocity which is determined purely according to what is physically and legally possible. Particularly careful drivers could perceive the empirical set velocity as being more comfortable. The set velocity can also be used to set a more comfortable way of driving in situations when the quality of the road is poor.

Overall, the empirically recorded acceleration data forms a very good data basis in order to derive a plurality of driving parameters which can be used to set different driving assistance, warning or assistance systems.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the scope of the following claims.

1-20. (canceled)

21. A method for determining a reference position as the basis for a correction of an absolute position of a vehicle located using a Global Satellite Navigation System (GNSS) comprising:
recording of the absolute position of the vehicle using the GNSS;
recording an output signal of a motion recording sensor of the vehicle;
recognizing when a characteristic progression is present in the output signal, wherein the characteristic progression represents a signal pattern which is dependent on uneven surfaces on the road;
determining the absolute position as the reference position;
assigning the reference position to the characteristic progression of the output signal; and
correcting an already stored reference position based on the absolute position using a learning method or the formation of an average value if the absolute position lies in an area around the stored reference position and the output signal represents a known signal pattern.

22. The method of claim 21, wherein the characteristic progression of the output signal is based on a predetermined surface structure of a road on which the vehicle is driving.

23. The method of claim 21, wherein the motion recording sensor measures at least one of a position, a velocity, and an acceleration of at least one component of the vehicle.

24. The method of claim 21, further comprising correcting the reference position based on a newly sensed absolute position when the characteristic progression in the output signal from the movement sensor is newly detected.

25. The method of claim 21, further comprising recording of a further absolute position of the vehicle when the output signal comprises a further characteristic progression which differs from the characteristic progression.

26. The method of claim 25, wherein an interval between the characteristic progression and the further characteristic progression fulfills a first predetermined condition.

27. The method of claim 21, further comprising deleting the reference position based on a second predetermined condition.

28. The method of claim 27, wherein the second predetermined condition is fulfilled when a degree of integrity for the assignment between the reference position and the characteristic progression of the output signal falls below a threshold value.

29. The method of claim 21, further comprising recording a map, by entering the specific reference position as a map position of a road into the map.

30. The method of claim 29, wherein the motion recording sensor is one of an acceleration sensor and a mobile device with an acceleration sensor.

31. The method of claim 30, wherein the progression of the acceleration of the acceleration sensor is recorded as linked to the reference position.

32. The method of claim 30, wherein a progression of a longitudinal acceleration sensor is recorded in relation to reference positions.

33. The method of claim 30, further comprising:
evaluating the acceleration progression, and
detecting uneven surfaces on the road on the basis of acceleration peaks.

34. The method of claim 33, further comprising detecting uneven surfaces on the road on the basis of a road image recorded using a camera.

35. The method of claim 33, further comprising producing at least one of a locally administered map and centrally administered map of uneven surfaces on the road.

36. The method of claim 33, wherein the uneven surfaces on the road are classified depending on acceleration peaks.

37. The method of claim 30, wherein the progression of the acceleration is linked to at least one of further driving situations, a driver type and vehicle parameters.

38. The method of claim 37, wherein by means of a cluster analysis of the acceleration progression and the respective parameters, acceleration progression clusters are formed.

39. The method of claim 30, wherein at least one of set velocities and hazardous points are derived from the progression of at least one of the acceleration and the uneven surfaces on the road.

40. A control device for a correction of an absolute position of a vehicle located using a Global Satellite Navigation System (GNSS) comprising:
a selection filter which recognizes and filters a characteristic progression is present in an output signal of a motion recording sensor of the vehicle, wherein the characteristic progression represents a signal pattern which is dependent on uneven surfaces on the road;
position determination facility to determine a reference position from an absolute position received by a vehicle GNSS receiver of the vehicle;
wherein the position determination facility assigns the reference position to the characteristic progression of the output signal; and
a merging filter to correct an already stored reference position based on the absolute position using one of: a learning method and the formation of an average value if the absolute position lies when an area around the stored reference position and the output signal represents a known signal pattern.

41. The control device of claim 40, wherein the characteristic progression of the output signal is based on a predetermined surface structure of a road on which the vehicle is driving.

42. The control device of claim 40, wherein the motion recording sensor measures at least one of a position, a velocity, and an acceleration of at least one component of the vehicle.

43. The control device of claim 40, wherein the reference position is corrected based on a newly sensed absolute position when the characteristic progression in the output signal from the movement sensor is newly detected.

44. The control device of claim 40, further comprising recording of a further absolute position of the vehicle when the output signal comprises a further characteristic progression which differs from the characteristic progression.

45. The control device of claim 44, wherein an interval between the characteristic progression and the further characteristic progression fulfills a first predetermined condition.

46. The control device of claim 40, wherein the reference position is deleted based on a second predetermined condition.

47. The control device of claim 46, wherein the second predetermined condition is fulfilled when a degree of integrity for the assignment between the reference position and the characteristic progression of the output signal falls below a threshold value.

48. The control device of claim 40, wherein a map is created by entering the specific reference position as a map position of a road into the map.

49. The control device of claim 48, wherein the motion recording sensor is one of an acceleration sensor and a mobile device with an acceleration sensor.

50. The control device of claim 49, wherein the progression of the acceleration of the acceleration sensor is recorded as linked to the reference position.

51. The control device of claim 49, wherein a progression of a longitudinal acceleration sensor is recorded in relation to reference positions.

52. The control device of claim 49, wherein the device evaluates the acceleration progression, and detects uneven surfaces on the road on the basis of acceleration peaks.

53. The control device of claim 52, wherein the device detects uneven surfaces on the road on the basis of a road image recorded using a camera.

54. The control device of claim 52, wherein the device produces at least one of a locally administered map and centrally administered map of uneven surfaces on the road.

55. The control device of claim 52, wherein the uneven surfaces on the road are classified depending on acceleration peaks.

56. The control device of claim 49, wherein the progression of the acceleration is linked to at least one of further driving situations, a driver type and vehicle parameters.

57. The control device of claim 18, wherein by means of a cluster analysis of the acceleration progression and the respective parameters, acceleration progression clusters are formed.

58. The control device of claim 49, wherein at least one of set velocities and hazardous points are derived from the progression of at least one of the acceleration and the uneven surfaces on the road.
